(19) United States
(12) Patent Application Publication
(10) Pub. No.: US 2019/0095964 A1
(43) Pub. Date: Mar. 28, 2019

(54) GUIDANCE ENABLED GROWTH

(71) Applicant: Go Daddy Operating Company, LLC, Scottsdale, AZ (US)

(72) Inventors: Justin Tsai, San Francisco, CA (US); Josh Berk, Scottsdale, AZ (US); Jared Lewandowski, Campbell, CA (US)

(21) Appl. No.: 15/713,328

(22) Filed: Sep. 22, 2017

(51) Int. Cl. G06Q 30/02; G06Q 10/06; G06F 17/30

(52) U.S. Cl. CPC G06Q 30/0282; G06F 17/3089; G06Q 10/0639

(57) ABSTRACT

A hosting company assists a business in improving a performance of its website. The hosting company hosts the website and determines properties of the business and other businesses that are stored in a benchmark database. Referencing past results of treatments stored in a score table, the website hosting company is more likely to select a treatment that has improved the performance of websites operated by similar businesses, than a treatment that has not improved the performance of websites operated by similar business. The treatment is performed by the business or website hosting company, and an effectiveness of the treatment on the website is measured. The measured effectiveness is compared against the measured effectiveness of other websites operated by similar businesses, to generate a score. The score, selected treatment and properties of the business are stored in the score table to assist in selecting treatments in future iterations of the method.

### FIELD OF THE INVENTION

The present invention generally relates to the field of improving a relative effectiveness of a website of a business as compared to websites of other similar businesses.

### SUMMARY OF THE INVENTION

The present invention provides systems and methods that may be practiced by a website hosting company to improve a relative effectiveness of one or more websites hosted by the website hosting company as compared to websites operated by other similar businesses.

A business operating a website may request that the website hosting company recommend or perform a treatment on its website to improve the relative performance of its website compared to other websites operated by similar businesses.

The website hosting company may determine a plurality of properties of the business that may be used in determining other businesses that are similar to the business. As non-limiting examples, the properties of the business that may be used in determining similar businesses may be an industry, a geography, a size (annual revenue, number of employees, number of customers, etc.), a time of operation, a type of service, a business experience of the owner/management and/or a budget for digital marketing.

A treatment generator of the website hosting company may use the properties of the business and the properties of the businesses in a score table to select a treatment for the website. While the treatment may be selected by any desired method, in preferred embodiments treatments that have improved the relative performance of websites of similar businesses in the past are more likely (but not always) to be selected as compared to treatments that have not improved the relative performance of websites of similar businesses in the past.

The website hosting company may suggest the treatment to the business operating the website and/or the website hosting company may perform the treatment on the website itself, preferably after getting approval from the business.

The website hosting company may measure an effectiveness of the treatment on the website using any desired method. As non-limiting examples, the website hosting company may measure, during a selected period of time, how long website visitors remain on the website, how often (or the average) number of engagements of the website visitors with the website, the number (or the average) of clicks on hyperlinks on the website, the number (or the average) of clicks on the telephone number and/or contact information listed by the website visitors on the website, the percent of website visitors that purchase goods and/or services from the website and/or the total revenue generated on the website from the website visitors. The effectiveness may be represented as a function of one or more of these (weighted) measurements or as a high dimensional number, using each of the measurements as a dimension.

The website hosting company may compare the effectiveness of the treatment on the website with the effectiveness of other websites that are operated by similar businesses to create a performance score for the selected treatment on the website. The effectiveness and plurality of properties of the other websites may be stored in a benchmark database created for this purpose.

The website hosting company may store the performance score, the selected treatment and the plurality of properties for the business operating the website in a score table. This process will continue to build the benchmark database and the score table so that the process of selecting treatments for future websites will be based on an ever increasing amount of data regarding treatments and their effectiveness as compared or relative to other websites operated by similar businesses.

The above features and advantages of the present invention will be better understood from the following detailed description taken in conjunction with the accompanying drawings.

### BRIEF DESCRIPTION OF THE DRAWINGS

FIG. 1 is a block diagram of a system that may be used to practice the invention of improving the relative effectiveness of a website operated by a business as compared to websites operated by similar businesses.

FIG. 2 is a block diagram of a method that may be used to practice the invention of improving the relative effectiveness of a website operated by a business as compared to websites operated by similar businesses.

FIGS. 3 and 4 are flowcharts of a method for improving the relative effectiveness of a website operated by a business as compared to websites operated by similar businesses.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

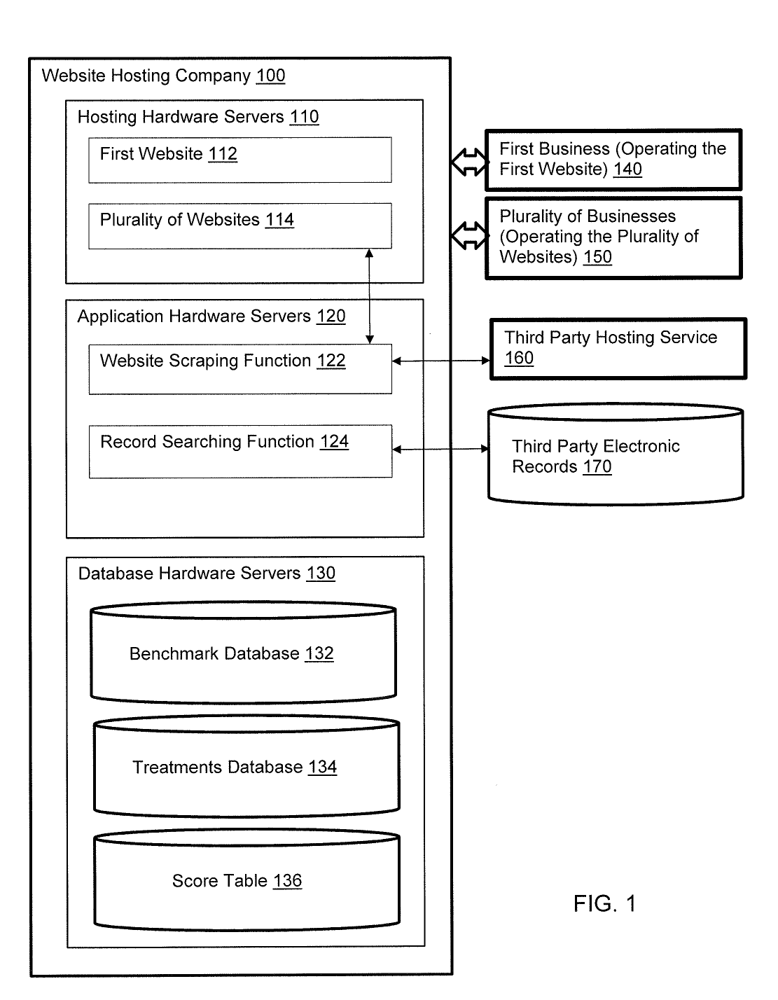

Referring to FIG. 1, the present invention may be practiced using one or more computer networks. A computer network is a collection of links and nodes (e.g., multiple computers and/or other client devices connected together) arranged so that information may be passed from one part of the computer network to another over multiple links and through various nodes. Examples of computer networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users on client devices. Hundreds of millions of people around the world have access to client devices connected to the Internet via Internet Service Providers (ISPs). Content providers place multimedia information (e.g., text, graphics, audio, video, animation, and other forms of data) at specific locations on the Internet referred to as websites 114. The combination of all the websites 114 and their corresponding web pages on the Internet is generally known as the World Wide Web (WWW) or simply the Web.

For Internet users and businesses 150 alike, the Internet continues to be increasingly valuable. More people use the Web for everyday tasks, from social networking, shopping, banking, and paying bills to consuming media and entertainment. E-commerce is growing, with businesses 150 delivering more services and content across the Internet, communicating and collaborating online, and inventing new ways to connect with each other.

Prevalent on the Internet are multimedia websites 114, some of which may offer and sell goods and services to individuals and organizations. Websites 114 may consist of a single webpage, but typically consist of multiple interconnected and related webpages. Websites 114, unless very large and complex or have unusual traffic demands, typically reside on a single server and are prepared and maintained by a single individual or entity (although websites 114 residing on multiple servers is certainly possible). Menus, links, tabs, etc. may be used to move between different web pages within the website or to move to a different website.

Websites 114 may be created using HyperText Markup Language (HTML) to generate a standard set of tags that define how the webpages for the website are to be displayed. Websites 114 may comprise titles, tags and text. Users of the Internet may access content providers' websites 114 using software known as an Internet browser, such as MICROSOFT INTERNET EXPLORER or MOZILLA FIREFOX. After the browser has located the desired webpage, it requests and receives information from the webpage, typically in the form of an HTML document, and then displays the webpage content for the user on the client device. The user may then view other webpages at the same website or move to an entirely different website using the browser.

Some Internet users, typically those that are larger and more sophisticated, may provide their own hardware, software, and connections to the Internet. Many Internet users either do not have the resources available or do not want to create and maintain the infrastructure necessary to host their own websites 114. To assist such individuals (or entities), hosting companies 160 exist that offer website hosting services. These hosting providers typically provide the hardware, software, and electronic communication means necessary to connect multiple websites 114 to the Internet. A single hosting provider may literally host thousands of websites 114 on one or more hosting servers.

Browsers are able to locate specific websites 114 because each website, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A Uniform Resource Locator (URL) is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization, specifically a domain name registry (registry), for maintaining an authoritative source for the registered domain names within a Top-Level Domain (TLD) and their corresponding name server(s) which may store an IP address for the domain name. For certain TLDs (e.g., .biz, .info, .name, and .org) the registry is also the authoritative source for contact information related to the domain name and is referred to as a “thick” registry. For other TLDs (e.g., .com and .net) only the domain name, registrar identification, and name server files are stored within the registry, and a registrar is the authoritative source for the contact information related to the domain name. Such registries are referred to as “thin” registries. Most domain names having a gTLDs are organized through a Shared Registration System (SRS) based on their TLD.

A domain name registrant (registrant) is hereby defined to be a person, entity or business 140 that is in the process of registering a domain name or has already registered a domain name. The person or business 140 is the registrant with respect to the domain name the registrant has registered. The registrant may use a client device, such as, as non-limiting examples, a cell phone, PDA, tablet, laptop computer, or desktop computer to access a website (such as a website of a domain name registrar) via a computer network, such as the Internet.

The process for registering a domain name with .com, .net, .org, and some other TLDs allows a registrant to use an ICANN-accredited domain name registrar to register a domain name. If a registrant, for example John Doe, wishes to register the domain name “mycompany.com,” John Doe may initially determine whether the desired domain name is available by contacting a domain name registrar (registrar). The registrant may request to register the domain name, preferably after the registrar has determined the domain name is available. The registrar may register the domain name to the registrant by notifying (and paying the applicable registration fees) the domain name registry (registry) that the registrant is requesting to register the domain name. If the domain name is still available, the registry will register the domain name to the registrant.

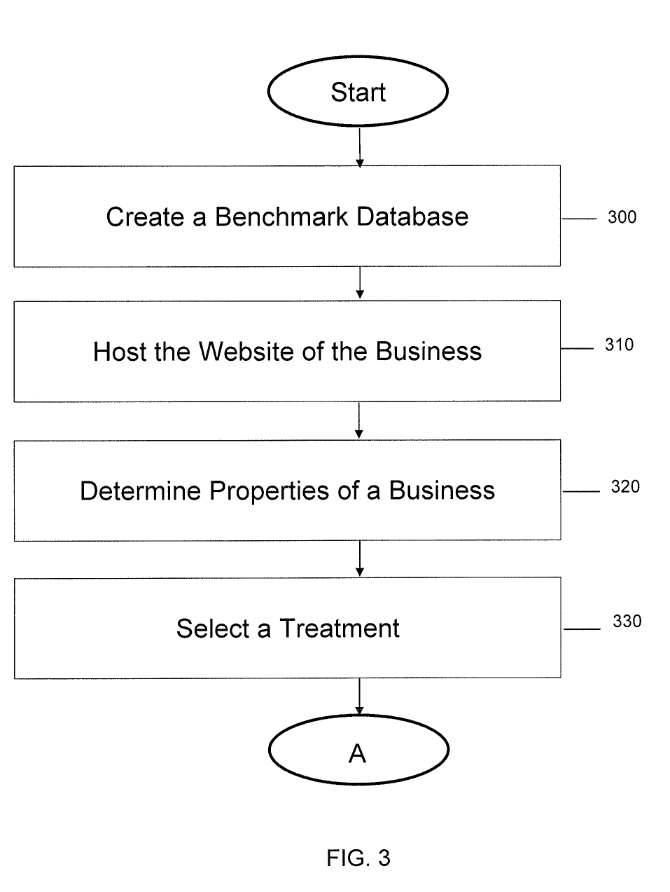

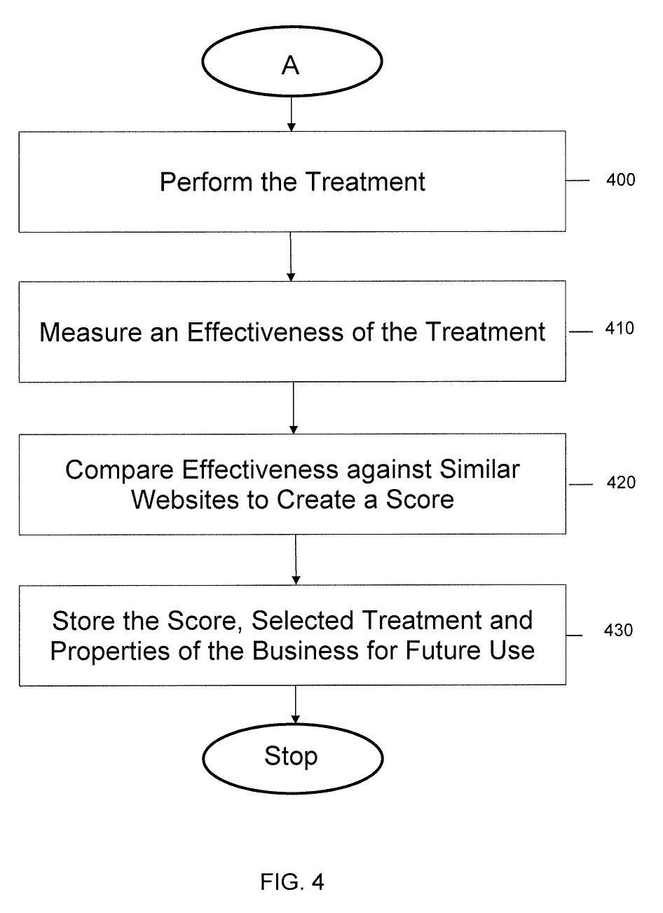

Referring to FIGS. 3 and 4, in many cases, the registrant may be a business 140 and desire to offer goods and/or services for sale on the Internet via a website 112 operated by the business 140. While the registrant may use a website hosting company 100 for hosting their website 112 that is a different from their registrar, in many cases the registrant and the website hosting company 100 will be the same company. The website hosting company 100 may host the website 112 for the business 140, thereby allowing all Internet users to have access to the website 112. (Step 310)

The website hosting company 100 is hereby defined to comprise, at a minimum, a plurality of hardware servers, hardware routers and other electronic hardware communication equipment necessary to allow the website hosting company 100 to host a plurality of websites 114 on the Internet. The hardware servers may be, as a non-limiting example, one or more Dell PowerEdge(s)® rack server(s) although other types of hardware servers or combinations of one or more hardware servers may be used.

Effectiveness

The business 140 will almost certainly want to have an effective website 112. With an effective website 112, website visitors are more likely to: remain on the website 112 longer, interact more fully with the website 112, click on more hyperlinks on the website 112, click on the telephone number and/or contact information listed on the website 112, purchase goods and/or services more frequently and/or for larger amounts from the website 112 of the business 140 operating the website 112. In contrast, a website 112 that is not effective will have website visitors that are more likely to: leave the website 112 quickly, have fewer interactions with the website 112, click on fewer hyperlinks on the website 112, not click on the telephone number and/or contact information, purchases goods and/or services less frequently and/or for smaller amounts, from the website 112 of the business 140 operating the website 112.

A measurement of an effectiveness of a website 112 may be calculated using any desired means. As a non-limiting example, an effectiveness of a website 112 may be a function of a total number of visits to the website 112 and/or a number of followers of one or more social media accounts of the business 140, multiplied by an effectiveness of the presence (search engine ranking, number of clicks on a listed phone number, number of interactions with a map, length of time on the website 112, number of submissions of contact forms, number of sales and/or size of sales within a predetermined or selected time period).

In another embodiment, effectiveness is a function of the site popularity and effectiveness on traffic. Popularity may be a function of site traffic, search engine optimization (SEO), quality of link-backs, etc. Effectiveness on traffic may be a function of a conversion rate on traffic, which includes calls, map directions called, clicks on reservation links, orders made on sites, services scheduled and contact form submissions entered.

Relative Effectiveness or Score

A business 140 may not only desire to have an effective website 112 (as described above), but to also have a website 112 that is more effective than the websites 114 of their competitors and/or similar businesses 150.

In determining which businesses 150 are similar to each other, a plurality of properties for each business may be compared against a plurality of properties of the other businesses 150. The same properties (items to measure) should be used for all of the businesses 150, but with different measured values for each property. The plurality of properties may be weighted (some properties may be more important than other properties in determining similar businesses 150) and/or subtracted from each other in high dimensional space. Similar businesses 150 will have a smaller absolute difference when subtracted from each other, while dissimilar businesses 150 will have a larger absolute difference when subtracted from each other. Similar businesses 150 may be defined to be within a predetermined amount/distance from the business 140 in high dimensional space or similar businesses 150 may be defined as, for example, the five closest (smallest distance in high dimensional space) businesses 150 to the business 140.

A relative effectiveness or a score is a measure of how successful a business's online presence is compared to other similar businesses' online presences. As an example, two websites 114 for two similar businesses, i.e., they sell similar products and/or services, sell products in a similar geographic area, have similar business annual incomes, have similar business ages, have similar business experiences of the owners/management, have similar budgets for digital marketing, have similar numbers of website visitors, and/or have a similar social media presence, may have very different effectivenesses. The difference of the effectiveness of a website 112 operated by a business 140 compared to websites 114 operated by similar businesses 150 may be considered the relative effectiveness or the score for the website 112. This has the advantage of allowing a website of a business to be compared against websites operated by similar businesses 150 and not compared against similar websites.

A business 140 may desire advice or modifications to its website 112 that would increase the effectiveness (resulting in a better relative effectiveness or score) of their website 112. In order to recommend updates or modify the website 112, it may be desirable for the website hosting company 100 to create a benchmark database 132 of properties for a plurality of other businesses 150 having a plurality of corresponding websites 114 for comparison. Each business in the plurality of business may have a plurality of properties that may be determined and stored in the benchmark database 132 that may be stored in one or more database hardware servers 130. (Step 300)

The plurality of properties for each business may be any desired properties (although the same properties should be collected, measured and used for all of the businesses 150) that may be helpful in determining which businesses 150 are similar to each other.

One of the plurality of properties of a business 140 may be an industry of the business 140. Each industry may be represented as a number in the benchmark database 132 and/or the score table 136. As examples of industries, an industry of the business 140 operating the website 112 might be plumbing, website design or handyman.

Another of the plurality of properties of a business 140 may be a geographical area. The geographical area may represent, as an example, a market area or service area of the business 140. Each geographical area may be represented as a number in the benchmark database 132 or the score table 136, preferably with geographical regions that are closer, or overlapping, being represented by numbers that are also closer to each other. The geographical areas may be broken down as desired, such as the breakdown of geographical areas from the Metropolitan Statistical Areas (MSAs) in the United States and/or equivalent geographical areas in other countries. As an example, a geographical area of the business 140 may be Phoenix, Arizona if all or substantially all of its sales are made in Phoenix, Arizona.

Another of the plurality of properties of a business 140 may be a size of the business 140. The size of the business 140 may be determined by any desired manner, such as being based on the number of employees, number of customers and/or gross annual sales. In some embodiments, a bucket may be selected, with each bucket being represented by a number. For example, the gross annual sales may have buckets of 1) $0-$5K, 2) $5K -$10K, 3) $10K-$25K, 4) $25K-$50K, 5) $50K-$100K, 6) $100K-$250K, 7) $250K-$500K, 8) $500K-$1M, 9) $1M-$10M, and 10) $10M+. Thus, in this example, a business 140 having gross annual sales of $40K may be represented by a 4 (in the $25K-$50K bucket).

Another of the plurality of properties of a business 140 may be a time in operation. The time in operation may be determined using any desired manner, such as counting from the date of incorporation, the date of making the first sale or the date of hosting the website 112 of the business 140. In some embodiments, a bucket may be selected, with each bucket being represented by a number. For example, the time in operation may be 1) not started yet, 2) 0 to 3 months, 3) 3 months to 6 months, 4) 6 months to 1 year, 5) 1 year to 2 years, 6) 2 years to 5 years, 7) 5 years to 10 years and 8) 10 years+. Thus, in this example, a business 140 having a time of operation of 3 years may be represented by the number 6, i.e., in the 2 years to 5 years bucket.

Another of the plurality of properties of a business 140 may be a type of service. As examples, the type of service may be selected from the categories of 1) personal, 2) hobby, 3) non-profit, 4) government, 5) sell products online, 6) sell products offline, 7) sell services online and 8) sell services offline. Thus, a website 112 for a business 140 that operates a restaurant may be considered as selling products offline (represented by a 6), if most of their sales are at the physical location of the restaurant.

Another of the plurality of properties of a business 140 may be the business experience of the owner and/or executives. The business experience of the owner and/or executives may be determined by any desired method, such as the length of time the owner has owned this business 140 plus the time the owner has owned any previous businesses. In some embodiments, a bucket may be selected with each bucket being represented by a number. For example, the business experience of the owner may be 1) no experience, 2) 0 to 1 year, 3) 1 year to 2 years, 4) 2 years to 5 years, 5) 5 years to 10 years and 6) more than 10 years. Thus, a business owner in this example with 12 years of experience may be represented by a 6 (more than 10 years of experience).

Another of the plurality of properties of a business 140 may be the budget for digital marketing. The size of the digital marketing budget may be determined by using any desired method, such as by counting the number and placement of ads each business purchased from known online advertisement placement platforms. The digital marketing budget may fall into a bucket that is preferably represented by a number. As an example, the budget of the digital marketing may be 1) $0-$10, 2) $10-$30, 3) $30-$60, 4) $60-$100, 5) $100-$250, 6) $250-$500, 7) $500-$1K, 8) $1K-$5K, 9) $5K-$10K, 10) $10K-$25K, 11) $25K-$50K, 12) $50K-$100K, 13) $100K-$500K, 14) $500K-$1M and 15) $1M+. In this example, a business 140 having a budget for digital marketing of $200 may be represented by a 5 (in the $100-$250 bucket).

The plurality of properties for each of the plurality of businesses 150 stored in the benchmark database 132 may be obtained by the website hosting company 100 using any desired method. As an example, the website hosting company 100 may comprise a website scraping function 122 to crawl, parse and/or scrape data from other websites 114 operated by businesses 150 already hosted by the website hosting company 100. The website hosting company 100 may also have data already entered by the businesses 150, which may be read by the website hosting company 100.

The website hosting company 100 may also use the website scraping function 122 to crawl, parse and/or scrape data from one or more websites 114 hosted by one or more third party hosting services 160. The website hosting company 100 may also use a record searching function 124 to search one or more third party electronic records 170. In this manner, the website hosting company 100 may obtain a plurality of properties for each business in a plurality of businesses 150 operating a corresponding website in a plurality of websites 114. The plurality of properties for each business in the plurality of businesses 150 may be stored in the benchmark database 132 and stored on one or more database hardware servers 130. The website scraping function 122 and record searching function 124 may run on one or more application hardware servers 120.

The website hosting company 100 may also determine a plurality of properties of the business 140 operating the website 112. (Step 320) This may be obtained by asking the business 140, crawling, parsing and/or scraping the website 112 of the business 140 and/or searching third party electronic records 170 related to the business 140. Alternatively or in addition, the website hosting company 100 may also determine a plurality of properties of the business 140 and/or benchmark businesses derived based on an IP address being used to contact the website hosting company 100 by the business under analysis; derived based on explicitly asking the user of the business under analysis for the properties; derived based on the site the user of the business under analysis came from, if the site gives off any signals; derived based on analysis of the site content; derived based on the EXIF metatags of images uploaded on the site; derived based on alt tags of the images on the site of the business; and/or based on links to third party sites (e.g., Tripadvisor or Yelp) and categories within those links. In this manner, the website hosting company 100 may determine the plurality of properties for the business 140 operating the website 112 and/or properties for the plurality of businesses 150 used in creating the benchmark database 132.

The website hosting company 100 may select a treatment, from a plurality of treatments stored in a treatments database 134 (which may be combined with one or more other databases), for the website 112. The treatments for the website 112 may be any possible change or update that may be made to the website 112. (Step 330)

A score table 136 may store for each business or website 112 a score or an effectiveness, a selected treatment used on the website and a plurality of properties for the business 140. While the score table 136 may have no or very little data at first, over time the data in the score table 136 will grow, thereby improving the selection process of treatments for websites in future iterations of the method.

A treatment generator, using the data in the score table 136, may select a treatment for the website 112 using any desired method. As a non-limiting example, the treatment generator may be more likely to select treatments that have improved the performance of websites 114 operated by similar businesses 150 in the past as compared to treatments that have not improved the performance of websites 114 operated by similar businesses 150 in the past. Initially, treatments may be selected based on no or very little data. However, as more and more treatments are selected and their effectiveness/scores are determined and stored in the score table 136, selected treatments may be based on more and more data. In preferred embodiments, new treatments may be subsequently added to the treatments in the score table 136 from time to time. As with the other treatments, weightings of the treatments may change over time as the effectiveness of the treatments change over time. In some embodiments, treatments that never or very rarely improve the effectiveness of the website 112 may be deleted or removed from the treatments stored in the score table 136.

It should be appreciated that it is desirable to not always recommend or select the treatment that has produced the best results in the past as this can lead to the overtraining of the treatment generator, where alternative treatments are no longer selected or evaluated. As the best treatments for any given website may change over time, it is desirable to include a randomizing effect in the treatment selection process. While the treatments that produce the best results are preferably selected the most often and/or are the most likely to be selected, it is also desirable to select from time to time treatments that have not produced the best results in the past. This allows the treatment selection process to continually evaluate a wide range of treatments. As a non-limiting example, the method may select a treatment 10% of the time that has not produced the best results in the past.

The website hosting company 100 may transmit the selected treatment for the website 112 to a client device of the business 140 and/or the website hosting company 100 may automatically perform (preferably after requesting and receiving permission from the business 140) the selected treatment on the website 112, possibly by editing the HTML code of the website stored on the hosting hardware servers 110. (Step 400)

As non-limiting examples, the treatments may be to: 1) emphasize a phone number, possibly by changing its design, such as by increasing a font size or increasing its contrast, 2) display a request to every website visitor to visit the business's social media account, 3) emphasize an email address of the business 140, 4) advise going subtle, such as non Call To Actions (CTA's) in the header, 5) find the most successful business in the same industry and make the website 112 have a similar appearance and/or features or 6) find the most successful business in the same geographic area and make the website 112 have a similar appearance and/or features.

The website hosting company 100 may wait some predetermined period of time and/or confirm that the selected treatment has been performed, either by the business 140 or the website hosting company 100, on the website 112. If the website hosting company 100 suggests the treatment to the client device of the business 140, the website hosting company may parse the code, such as the HTML, of the website stored on the one or more hosting hardware servers 110 to determine whether the business updated or altered the website according to the treatment suggestion. The website hosting company may periodically check the website 112 to determine when the treatment has been completed on the website 112.

The website hosting company 100 may measure an effectiveness of the selected treatment for the website 112. (Step 410) The effectiveness may be measured by any desired method, such as by measuring over a selected period of time: 1) how long website visitors remain on the website 112, 2) the number of interactions the website visitors have with the website 112, 3) the number of clicks on hyperlinks the website visitors perform on the website 112, 4) the number of clicks on the telephone number and/or contact information listed the website visitors perform on the website 112, 5) the number of website visitors that purchase goods and/or services from the website 112 and/or 6) the dollar amount of purchases from the website visitors for the goods and/or services of the business 140 operating the website 112. A function (that weights these and/or other selected measured variables) may be used to produce or calculate an effectiveness of the selected treatment for the website 112.

The website hosting company 100 may compare the measured effectiveness of the selected treatment for the website 112 with an average effectiveness of websites 114 operated by similar businesses 150. (Step 420) The effectiveness of other websites 114, along with a plurality of properties for the corresponding businesses 150, may be read from the benchmark database 132. The effectiveness of the website 112 and the plurality of properties for its business 140 may be stored in the benchmark database 132 for use by future iterations of this method.

Any desired process for selecting websites 114 operated by similar businesses 150 may be used. As a non-limiting example, a predetermined number, such as five, of the businesses that are closest in high dimensional space to the business 140 operating the website 112 may be chosen. As another non-limiting example, a set of known websites in a given industry may be analyzed and the one or more properties that provide the strongest signals for websites within that specific industry may be used as the independent variables in determining similar businesses. The independent variables may then be analyzed to a random group of businesses to determine which businesses are most similar to each other.

The comparison may be used to generate a score for the selected treatment on the website 112. The score may be based on the measured effectiveness of the website 112 and the effectiveness of websites 114 operated by similar businesses 150. As a non-limiting example, the score may be the average effectiveness of websites 114 operated by similar businesses 150 subtracted from the effectiveness of the website 112 operated by the business, i.e., score=(effectiveness of the website)−(average effectiveness of other websites operated by similar businesses).

The website hosting company 100 may store the score for the website 112, the selected treatment on the website 112 and the plurality of properties for the business 140 operating the website 112 in a score table 136. The score table 136 may be stored in a physical database so as to be configured to improve a future website operated by a future business having its own plurality of properties. The score table 136 may then be used by the treatment generator for future websites wanting to have an improved effectiveness and/or an improved relative effectiveness (score) compared to similar businesses 150 having websites 114. (Step 430)

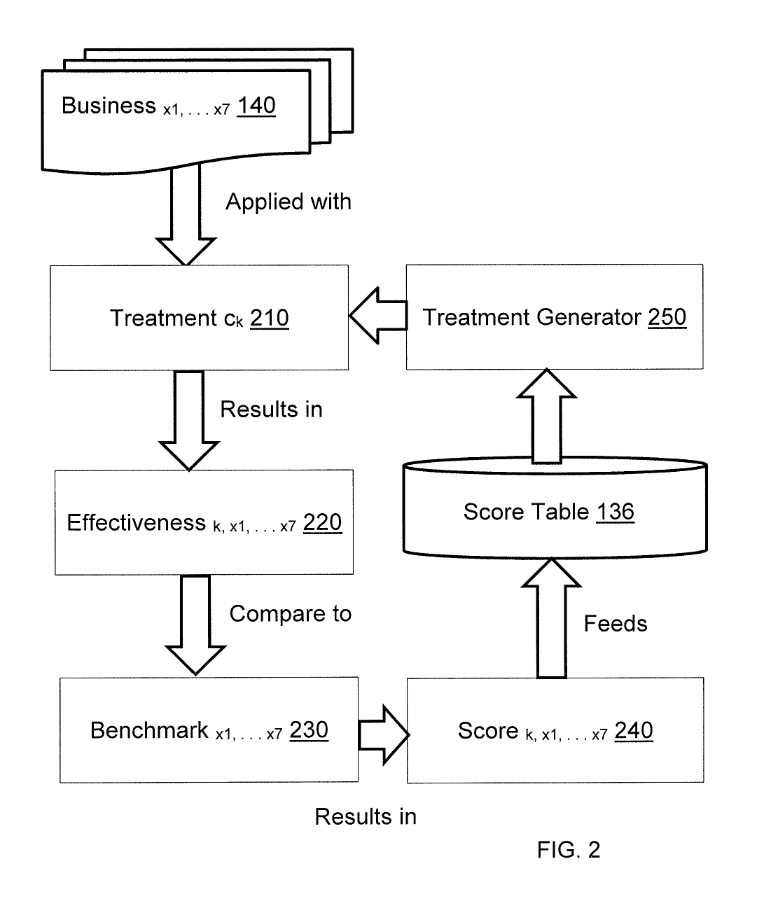

Referring to FIG. 2, a method is illustrated for a website hosting company 100 to improve the relative effectiveness of a hosted website 112 operated by a business 140 compared to the effectiveness of websites 114 operated by other businesses 150 that are similar to the business 140. The website hosting company 100 may offer or the business 140 may request a suggested treatment for a website 112 operated by the business 140.

The website hosting company 100 may obtain a plurality of properties for the business 140, using any of the previously described methods.

Using the plurality of properties, the website hosting company 100 may use a treatment generator 250 to review treatments stored in a score table 136 previously performed on websites 114 operated by other similar businesses 150. The treatment generator 250 may be more likely to, but preferably not always, select a treatment 210 from the score table 136 that most improved a relative effectiveness of websites 114 that are operated by other similar businesses 150. As an example, the selected treatment 210 may be to emphasize a telephone number of the business 140 on a home page of the website 112.

The website hosting company 100 may suggest/transmit the selected treatment to the business 140 and/or the website hosting company 100, preferably after requesting and obtaining permission from the business 140, may perform the treatment on the website 112, possibly by modifying the code (such as HTML) stored on the hosting hardware servers 110. In some embodiments, the website hosting company 100 may give the business 140 the option to perform the selected treatment 210 itself or have the website hosting company 100 perform the selected treatment 210.

After some period of time, the website hosting company 100 may measure an effectiveness 220 of the treatment on the website 112. As examples, the website hosting company 100 may measure how long an average website visitor remains at the website 112 and/or the average number of clicks on hyperlinks on the website 112 clicked by the website visitors.

The website hosting company 100 may compare the measured effectiveness of the treatment on the website 112 against previously measured effectiveness of websites 114 of other similar businesses 150 stored in a benchmark database 230. Comparing against websites 114 of other similar businesses 150 assists in making sure the comparison is an apple-to-apple comparison and not an apple-to-orange comparison. The comparison may comprise subtracting the average effectivenesses of the websites 114 of other similar businesses 150 from the effectiveness of the website 112 to generate a score.

A positive or a high score indicates the treatment on the website 112 improved the performance or a relative effectiveness of the website 112 for the business 140 compared to the performance or effectiveness of websites 114 operated by other similar businesses 150. On the other hand, a negative or a low score indicates the treatment on the website 112 did not improve the performance or the relative effectiveness of the website 112 for the business 140 compared to the performance or effectiveness of websites 114 operated by other similar businesses 150.

The plurality of properties for the business 140, the selected treatment, the effectiveness and the score may be stored in the benchmark database 132 and/or the score table 136. As the system continues to be used, it will have an ever growing pool of data to use in the benchmark database 132 and the score table 136, which will improve the process for selecting treatments in future iterations for future websites that use the above method.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A method for improving an effectiveness of a website, comprising the steps of:
creating, by a website hosting company comprising a plurality of hardware servers, a benchmark database comprising a plurality of properties for each business in a plurality of businesses operating a corresponding website in a plurality of websites by:
searching available electronic records for each business in the plurality of businesses,
scraping each corresponding website in the plurality of websites,
thereby determining the plurality of properties for each business in the plurality of businesses and
storing the plurality of properties for each business in the plurality of businesses in the benchmark database;
hosting, by the website hosting company, a first website on the Internet using one or more hardware servers, wherein the first website is used to sell goods and/or services of a first business;
determining, by the website hosting company, a first plurality of properties of the first business operating the first website;
selecting, by the website hosting company, a treatment from a plurality of treatments, wherein treatments in the plurality of treatments that have higher relative performance scores for websites operated by businesses similar to the first business are more likely to be selected than treatments in the plurality of treatments that have lower relative performance scores for websites operated by businesses similar to the first business;
transmitting, by the website hosting company, the selected treatment for the first website to a client device of the first business or performing, by the website hosting company, the selected treatment on the first website;
measuring, by the website hosting company, an effectiveness of the selected treatment for the first website;
comparing, by the website hosting company, the effectiveness of the selected treatment for the first website with an average effectiveness of the websites in the plurality of websites that are operated by business that are the most similar to the first business to generate a performance score for the selected treatment on the first website operated by the first business having the first plurality of properties; and
storing, by the website hosting company, the performance score, the selected treatment and the first plurality of properties in a score table stored in a physical database so as to be configured to improve a second website operated by a second business having a second plurality of properties.

2. The method of claim 1, wherein the comparing the effectiveness of the selected treatment for the first website with the average effectiveness of the websites in the plurality of websites that are operated by businesses that are the most similar to the first business comprises subtracting the average effectiveness of the websites in the plurality of websites that are operated by businesses that are the most similar to the first business from the effectiveness of the selected treatment for the first website.

3. The method of claim 1, wherein the selected treatment was from the plurality of treatments that have the lower relative performance scores for websites operated by businesses that are the most similar to the first business.

4. The method of claim 1, wherein all of the plurality of websites are hosted by the website hosting company.

5. The method of claim 1, wherein not all of the plurality of websites are hosted by the website hosting company.

6. The method of claim 1, wherein the step of measuring the effectiveness of the selected treatment for the first website comprises the steps of:
determining a number of visitors to the first website over a given period of time,
determining a number of visitors over a given period of time to a social media account of the first business and
determining a search engine ranking for the first website.

7. The method of claim 1, wherein the plurality of properties for each business in the plurality of businesses comprises an indication of the type of business the business is in, an indication of an annual income of the business and an indication of how long the business has been operating.

8. A method for improving an effectiveness of a website, comprising the steps of:
creating a benchmark database comprising a plurality of properties for each business in a plurality of businesses operating a corresponding website in a plurality of websites, wherein the plurality of properties for each business comprises an industry of the business, a geography of the business, a size of the business, a time in operation of the business and a type of service of the business;
storing the plurality of properties for each business in the plurality of businesses in the benchmark database;
hosting, by the website hosting company, a first website on the Internet using one or more hardware servers, wherein the first website is used to sell goods and/or services of a first business;
determining a first plurality of properties of the first business operating the first website;
selecting a treatment from a plurality of treatments, wherein treatments in the plurality of treatments that have improved performance for websites operated by businesses similar to the first business in the past are more likely to be selected than treatments in the plurality of treatments that have not improved performance for websites operated by businesses similar to the first business in the past;
transmitting the selected treatment for the first website to a client device of the first business or performing, by the website hosting company, the selected treatment on the first website;
measuring an effectiveness of the selected treatment for the first website;
comparing the effectiveness of the selected treatment for the first website with an average effectiveness of the websites in the plurality of websites that are operated by businesses that are the most similar to the first business to generate a score for the selected treatment on the first website operated by the first business having the first plurality of properties; and
storing the score, the selected treatment and the first plurality of properties in a score table stored in a physical database so as to be configured to improve a second website operated by a second business having a second plurality of properties.

9. The method of claim 8, wherein the comparing the effectiveness of the selected treatment for the first website with the average effectiveness of the websites in the plurality of websites that are operated by businesses that are the most similar to the first business, comprises subtracting the average effectiveness of the websites in the plurality of websites that are operated by businesses that are the most similar to the first business from the effectiveness of the selected treatment for the first website.

10. The method of claim 8, wherein the selected treatment was from the plurality of treatments that have not improved performance in the past for websites operated by businesses that are similar to the first business.

11. The method of claim 8, wherein all of the plurality of websites are hosted by the website hosting company.

12. The method of claim 8, wherein not all of the plurality of websites are hosted by the website hosting company.

13. The method of claim 8, wherein the step of measuring the effectiveness of the selected treatment for the first website comprises the steps of:
determining a number of visitors to the first website over a given period of time,
determining a number of visitors to a social media account of the first business over a given period of time and
determining a search engine ranking for the first website.

14. A method for improving an effectiveness of a website, comprising the steps of:
creating a benchmark database comprising a plurality of properties for each business in a plurality of businesses operating a corresponding website in a plurality of websites;
storing the plurality of properties for each business in the plurality of businesses in the benchmark database;
hosting, by the website hosting company, a first website on the Internet using one or more hardware servers, wherein the first website is used to sell goods and/or services of a first business;
determining a first plurality of properties of the first business operating the first website;
selecting a treatment from a plurality of treatments based on a past performance for each of the plurality of treatments on websites operated by businesses similar to the first business;
transmitting the selected treatment for the first website to a client device of the first business or performing, by the website hosting company, the selected treatment on the first website;
measuring an effectiveness of the selected treatment for the first website;
comparing the effectiveness of the selected treatment for the first website with an average effectiveness of the websites in the plurality of websites that are operated by businesses that are the most similar to the first business to generate a score for the selected treatment on the first website operated by the first business having the first plurality of properties; and
storing the score, the selected treatment and the first plurality of properties in a score table stored in a physical database so as to be configured to improve a second website operated by a second business having a second plurality of properties.

15. The method of claim 14, wherein the comparing the effectiveness of the selected treatment for the first website with the average effectiveness of the websites in the plurality of websites that are operated by businesses that are the most similar to the first business comprises subtracting the average effectiveness of the websites in the plurality of websites that are operated by business that are the most similar to the first business from the effectiveness of the selected treatment for the first website.

16. The method of claim 14, wherein the selected treatment was from the plurality of treatments that have not improved performance in the past for websites operated by businesses that are the most similar to the first business.

17. The method of claim 14, wherein all of the plurality of websites are hosted by the website hosting company.

18. The method of claim 14, wherein not all of the plurality of websites are hosted by the website hosting company.

19. The method of claim 14, wherein the plurality of properties for each business in the plurality of businesses comprises an indication of the type of business the business is in, an indication of an annual income of the business and an indication of how long the business has been operating.

20. The method of claim 14, wherein the step of measuring the effectiveness of the selected treatment for the first website comprises the steps of:
determining a number of visitors to the first website over a given period of time,
determining a number of visitors to a social media account of the first business over a given period of time and
determining a search engine ranking for the first website.
